(19) United States
(12) Patent Application Publication
(10) Pub. No.: US 2014/0013140 A1
(43) Pub. Date: Jan. 9, 2014

(54) INFORMATION PROCESSING APPARATUS AND COMPUTER PROGRAM PRODUCT

(71) Applicant: KABUSHIKI KAISHA TOSHIBA, Tokyo (JP)

(72) Inventors: Junichi Segawa, Kanagawa (JP); Tatsunori Kanai, Kanagawa (JP); Koichi Fujisaki, Kanagawa (JP); Tetsuro Kimura, Tokyo (JP); Haruhiko Toyama, Kanagawa (JP); Satoshi Shirai, Kanagawa (JP); Masaya Tarui, Kanagawa (JP); Hiroyoshi Haruki, Kanagawa (JP); Yusuke Shirota, Kanagawa (JP); Akihiro Shibata, Tokyo (JP)

(21) Appl. No.: 13/928,904

(22) Filed: Jun. 27, 2013

(30) Foreign Application Priority Data
Jul. 9, 2012 (JP) 2012-153615

(51) Int. Cl. G06F 1/32

(52) U.S. Cl. CPC G06F 1/3234
USPC 713/323

(57) ABSTRACT

According to an embodiment, an information processing apparatus includes a processor, a first memory, and a power supply controller. The processor is configured to execute a program. The first memory is configured to store therein the program. The power supply controller is configured to stop supplying a power to the first memory when the processor transitions to an idle state where the processor waits for an interrupt, and start supplying the power to the first memory when the processor receives the interrupt in the idle state. When the processor receives the interrupt in the idle state, the processor executes initialization of the first memory to set the first memory into a state where the first memory is accessible from the processor.

### CROSS-REFERENCE TO RELATED APPLICATION(S)

This application is based upon and claims the benefit of priority from Japanese Patent Application No. 2012-153615, filed on Jul. 9, 2012; the entire contents of which are incorporated herein by reference.

### FIELD

Embodiments described herein relate generally to an information processing apparatus and a computer program product.

### BACKGROUND

Embedded devices such as a mobile phone and a tablet terminal need to operate with limited power of a battery or similar unit. Thus, reducing power consumption of the devices is one of major technical problems. Power consumption of memory in the embedded devices has been increasing with an increase in an amount of installed memory in recent years. Thus it is increasingly important to suppress power consumption of memory to reduce power consumption of the devices.

A known technique for suppressing power consumption of memory makes a memory transition to a power-saving mode when a processor transitions to an idle state where the processor waits for an interrupt, thus suppressing power consumption of memory. For example, when the processor transitions to the interrupt waiting state, a known technique makes a memory transition to the power-saving mode in which power consumption is lower than a normal operation mode. When an interrupt occurs in the power-saving mode, the memory is returned to the normal operation mode. Thus power consumption of memory is reduced.

With the conventional technique, when a processor transitions to the interrupt waiting state, a memory transitions to the power-saving mode, thus reducing power consumption of memory. However, the memory consumes the power even in the power-saving mode. Thus a problem that power consumption is not sufficiently reduced arises.

### BRIEF DESCRIPTION OF THE DRAWINGS

FIG. 1 is a block diagram illustrating an information processing apparatus according to an embodiment;

FIG. 2 is a conceptual diagram illustrating a first memory and a second memory according to the embodiment;

FIG. 3 is a flowchart of an exemplary operation of a processor according to the embodiment;

FIG. 4 is a conceptual diagram illustrating a state, which is after a transition to an idle state, of the second memory according to the embodiment; and

FIG. 5 is a flowchart of an exemplary operation of the processor according to the embodiment.

### DETAILED DESCRIPTION

According to an embodiment, an information processing apparatus includes a processor, a first memory, and a power supply controller. The processor is configured to execute a program. The first memory is configured to store therein the program. The power supply controller is configured to stop supplying a power to the first memory when the processor transitions to an idle state where the processor waits for an interrupt, and start supplying the power to the first memory when the processor receives the interrupt in the idle state. When the processor receives the interrupt in the idle state, the processor executes initialization of the first memory to set the first memory into a state where the first memory is accessible from the processor.

Various embodiments will be described in detail below by referring to the accompanying drawings.

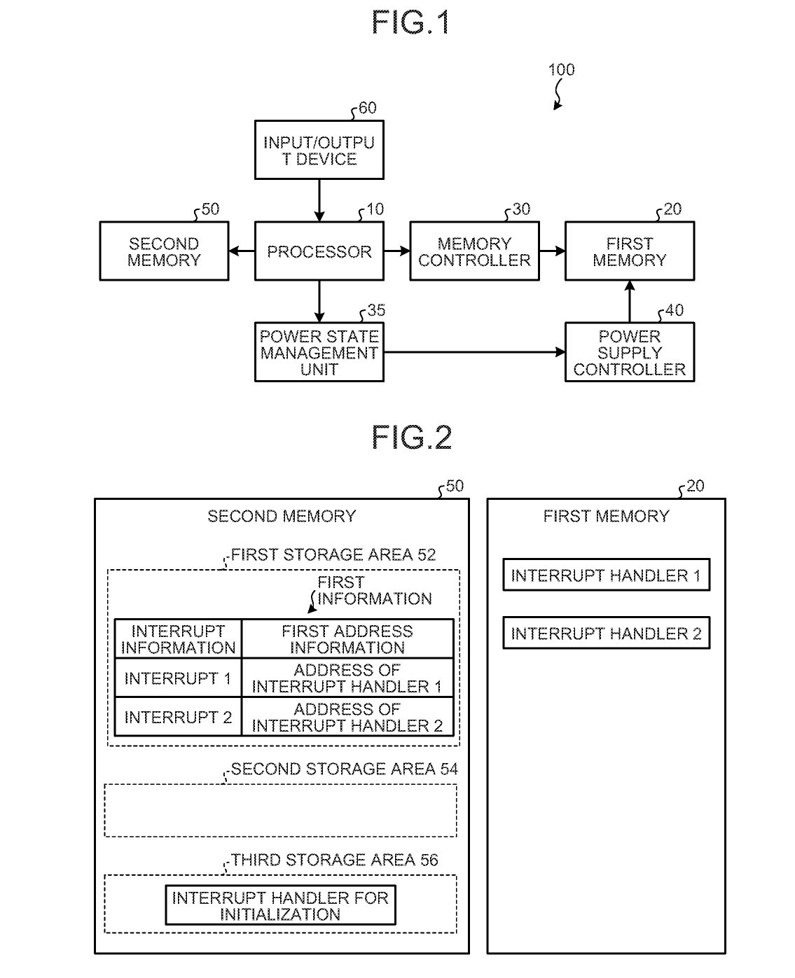

FIG. 1 is a block diagram illustrating an exemplary configuration of an information processing apparatus 100 according to the embodiment. As illustrated in FIG. 1, the information processing apparatus 100 includes a processor 10, a first memory 20, a memory controller 30, a power state management unit 35, a power supply controller 40, a second memory 50, and an input/output device 60.

The processor 10 is a processing unit that executes programs stored in the first memory (main memory) 20 to execute various types of processing. The programs stored in the first memory 20 includes an interrupt program (interrupt handler) described below. The processor 10 has a function to receive an interrupt, which is notified from the input/output device 60. The processor 10 transitions between an active state and an idle state. In the active state, the processor 10 executes a program (processing). In the idle state, the processor 10 waits for an interrupt (more specifically, the idle state is a state where the processor 10 waits for an interrupt without executing a program (processing)). In the active state, the processor 10 accesses the first memory 20 as necessary, and the processor 10 does not access the first memory 20 in the idle state. Some processors have a plurality of kinds of the idle states depending on their power-saving functions. Any processor may be employed as the processor 10 according to this embodiment insofar as it does not access the first memory 20 in the idle state, and transitions to the active state at the timing of receiving an interrupt.

The first memory 20 is a main memory that stores therein information (such as data and a program) used for processing executed by the processor 10. The first memory 20 is coupled to the processor 10 via the memory controller 30. Generally, a high-speed and large-capacity memory, which is employed for the main memory of an application processor, is configured to be accessed at high speed using a synchronous interface (that is, it is configured with synchronous memory). The first memory 20 according to this embodiment is configured with a synchronous non-volatile memory. For example, the first memory 20 may employ MRAM (Magnetoresistive Random Access Memory), FeRAM, PCM, ReRAM, or other kinds of memory.

The synchronous memory needs to be initialized after the power is turned on, in order to be set into a state where the memory is accessible from the processor 10. In this embodiment, when the power begins to be supplied to the first memory 20 (when the power is turned on), the processor 10 initializes the first memory 20 to set the first memory 20 into a state where the first memory 20 is accessible from the processor 10. More specifically, the processor 10 inputs a setting value for initialization to a control register in the memory controller 30, and instructs the memory controller 30 to start an initialization process. Then, the memory controller 30 receives the instruction from the processor 10 and then executes the initialization process. The initialization process varies depending on the kind of the synchronous interface. Many of the initialization processes are a process where a NOP command continues to be issued for a certain period, and then a command for setting a burst length or a parameter value (such as a resistance value) of a signal line is issued.

The power state management unit 35 receives a signal, which indicates whether the processor 10 is in the active state or in the idle state, from the processor 10, and then outputs a standby signal to the power supply controller 40. That is, the power state management unit 35 outputs the standby signal in order to instruct the power supply controller 40 to turn on or off supplying the power to the first memory 20. The power state management unit 35 may monitor whether the processor 10 is in the active state or in the idle state, and then output the standby signal to the power supply controller 40 based on the monitoring. The power state management unit 35 may be referred to as Power Reset Manager, General Power Controller, Low-Leakage Wakeup Unit, or other names, and may be provided as a part of functions of SoC.

The power supply controller 40 controls the power that is supplied from a power supply unit (such as a battery, not shown) of the information processing apparatus 100 to the first memory 20. Whether a supply of the power to the first memory 20 is available or not can be set with the power supply controller 40, depending on the state of the processor 10. For example, a power management IC, which is referred to as PMIC, may be employed for the power supply controller 40.

The second memory 50 stores therein an initialization program to initialize the first memory 20. A specific configuration of the second memory 50 is described later. For example, the second memory 50 may be configured with a memory that does not require initialization for setting the second memory 50 into a state where the second memory 50 is accessible from the processor 10. For example, a memory such as an internal memory configured with SRAM, which is included in SoC (System-on-a-chip), may be used as the second memory 50. The internal memory is accessible from the processor 10 immediately after the processor 10 is returned to the active state, without initialization. Accordingly, the internal memory may be used as the second memory 50.

For example, a memory such as DRAM, which requires initialization, can be also used as the second memory 50 as follows. A power supply management, which is different from the first memory 20, is employed, and the second memory 50 is controlled to be continuously supplied with the power such that the second memory 50 is accessible from the processor 10 immediately after the processor 10 is returned to the active state from the idle state. In this embodiment, the second memory 50 is provided separately from the processor 10, but not limited to this. For example, the second memory 50 may be provided inside the processor 10.

The input/output device 60 is a device that notifies the processor 10 of an interrupt from a device. The input/output device 60 includes various devices, which generate interrupts. The various devices include an operation device such as a keyboard and a touchscreen; a storage device such as a HDD and NAND flash memory; and a network device such as a wireless LAN and a network interface card. The interrupt controller receives an interrupt from a device. Depending on settings, the interrupt controller then executes operations for transmitting the interrupt, which is received from the device, to the processor 10, accumulating interrupts, which are received from the device, for a certain period (or accumulating a certain number of the interrupts) without transmitting the interrupts to the processor 10, and the like. In the example in FIG. 1, the processor 10, the memory controller 30, the interrupt controller in the input/output device 60, the second memory 50, and the power state management unit 35 are illustrated as separate blocks. However these may be configured with a SoC, which has equivalent functions inside.

FIG. 2 is a conceptual diagram illustrating an exemplary configuration of the first memory 20 and the second memory 50. As illustrated in FIG. 2, the first memory 20 stores therein an interrupt program (hereinafter referred to as “interrupt handler”), which is executed when an interrupt occurs. In the example in FIG. 2, there are an “interrupt 1” and an “interrupt 2” as types of interrupts. The first memory 20 stores an interrupt handler 1, which is executed when the “interrupt 1” occurs, and an interrupt handler 2, which is executed when the “interrupt 2” occurs. In other words, the first memory 20 stores, for each interrupt, an interrupt handler executed when the interrupt occur.

As illustrated in FIG. 2, the second memory 50 includes a first storage area 52, a second storage area 54, and a third storage area 56. The first storage area 52 stores first information, which associates interrupt information with first address information. The interrupt information identifies the type of interrupts. The first address information specifies an area where an interrupt handler is stored in the first memory 20. The interrupt handler is executed when an interrupt, which is identified by the interrupt information, occurs. The first storage area 52 corresponds to the “first storage unit” in the claims. In the example in FIG. 2, the first information is stored in the first storage area 52. The first information associates the “interrupt 1” indicative of the interrupt information with an “address of the interrupt handler 1” that specifies an area where the interrupt handler 1 is stored in the first memory 20. The interrupt handler 1 is executed when the “interrupt 1” occurs. The first information also associates the “interrupt 2” indicative of the interrupt information with an “address of the interrupt handler 2” that specifies an area where the interrupt handler 2 is stored in the first memory 20. The interrupt handler 2 is executed when the “interrupt 2” occurs.

The second storage area 54 serves as a saving area for saving the first information that is stored in the first storage area 52. Detailed functions of the second storage area 54 are described later. The second storage area 54 corresponds to the “second storage unit” in the claims. The third storage area 56 stores therein an interrupt handler for initialization, which includes an initialization program to initialize the first memory 20. The interrupt handler for initialization includes not only the initialization program but also a program to access (to execute a jump process to) an area where an interrupt handler, which corresponds to an interrupt that has occurred, is stored in the first memory 20.

In this embodiment, when the processor 10 transitions to the idle state where the processor 10 waits for an interrupt, the power supply controller 40 controls to stop supplying the power to the first memory 20. On the other hand, when the processor 10 receives an interrupt in the idle state, the power supply controller 40 controls to start supplying the power to the first memory 20, and then the processor 10 initializes the first memory 20. After the processor 10 finishes initialization of the first memory 20, the processor 10 obtains the interrupt handler corresponding to the received interrupt from the first memory 20, thus executing the obtained interrupt handler (execute an interrupt process). This process will be specifically described below.

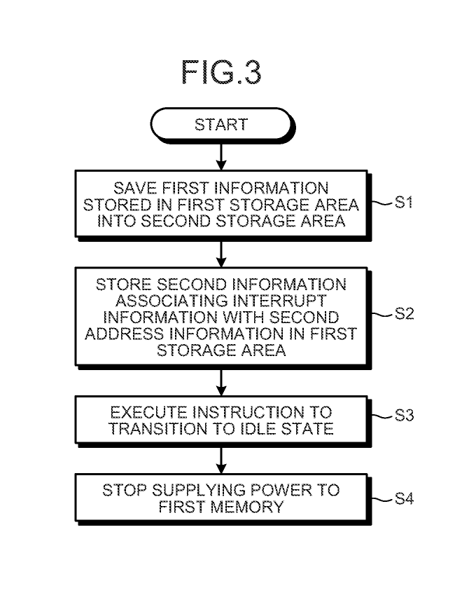

FIG. 3 is a diagram illustrating a flowchart of an exemplary operation process when the processor 10 has no more tasks to execute, and transitions to the idle state. As illustrated in FIG. 3, the processor 10 first saves (copies) the first information, which is stored in the first storage area 52, into the second storage area 54 (step S1). This should not be construed in a limiting sense and may be configured as follows. For example, the interrupt information alone is preliminarily registered in the second storage area 54. The processor 10 obtains the first address information, which corresponds to each piece of interrupt information from the first information stored in the first storage area 52. Each piece of the interrupt information is preliminarily registered in the second storage area 54. The processor 10 associates the obtained first address information with the interrupt information in the second storage area 54, and then writes the obtained first address information.

Next, the processor 10 stores, in the first storage area 52, second information in which the interrupt information and second address information that specifies a location of the third storage area 56 in the second memory 50 are associated with each other (step S2). In this embodiment, the processor 10 associates each piece of interrupt information that remains in the first storage area 52, with the address (the second address information) of the interrupt handler for initialization, thereby generating the second information. The processor 10 then stores the generated second information in the first storage area 52. For example, in step S1 described above, in the case where the first information, which is stored in the first storage area 52, is directly moved to the second storage area 54 instead of copying, any data does not remain in the first storage area 52 immediately before step S2. However, the processor 10 may associate each piece of interrupt information included in the first information, which is moved to the second storage area 54, with the address (the second address information) of the interrupt handler for initialization, thereby generating the second information. The processor 10 may then store the generated second information in the first storage area 52.

Next, the processor 10 stores the second information, in which the interrupt information is associated with the second address information that specifies the location of the third storage area 56 in the second memory 50, in the first storage area 52 (step S2).

Next, the processor 10 issues an instruction (such as a WFI (Wait For Interrupt) instruction) to transition to the idle state where the processor 10 waits for an interrupt (step S3). Then the power state management unit 35 transmits a notification that indicates that the processor 10 is in the idle state, or a request to stop supplying the power, to the power supply controller 40. Subsequently, the power supply controller 40 controls to stop supplying the power to the first memory 20 (step S4).

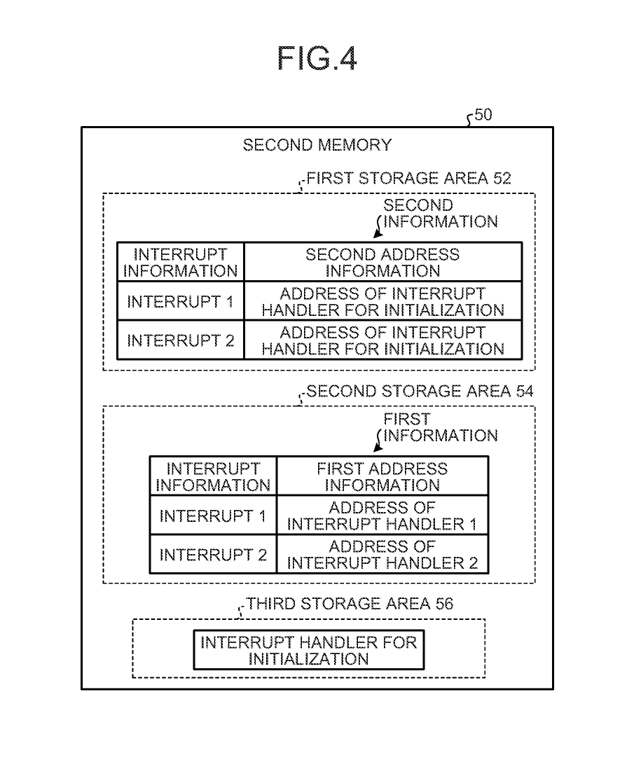

FIG. 4 is a conceptual diagram illustrating an exemplary configuration of the second memory 50 after a transition to an idle state. As described above, when the processor 10 transitions to the idle state, the processor 10 saves the first information stored in the first storage area 52 into the second storage area 54, and stores the second information, in which each piece of interrupt information is associated with the address (the second address information) of the interrupt handler for initialization, in the first storage area 52. This allows initialization of the first memory 20 when recovering in response to an interrupt reception.

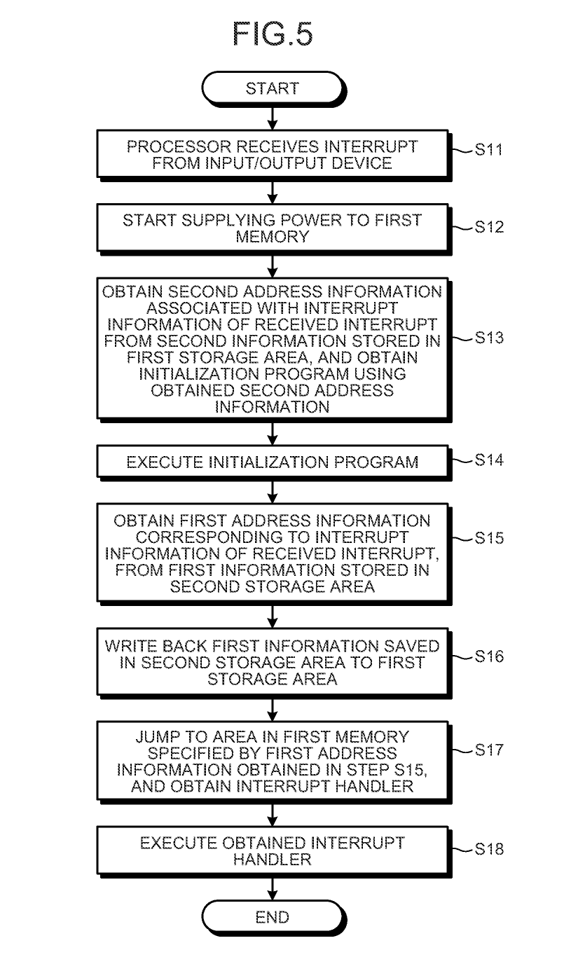

FIG. 5 is a diagram illustrating a flowchart of an exemplary operation process in the case where the processor 10 receives an interrupt in the idle state. As illustrated in FIG. 5, the processor 10 first receives an interrupt from the input/output device 60 (step S11). Then, the processor 10 transitions to the active state, and the power state management unit 35 transmits a notification indicating that the processor 10 is in the active state, or a request to supply the power, to the power supply controller 40. In response, the power supply controller 40 controls to start supplying the power to the first memory 20 (step S12).

Next, the processor 10 obtains the second address information (the address of the interrupt handler for initialization), which is associated with the interrupt information that identifies the received interrupt, from the second information stored in the first storage area 52 of the second memory 50. Then the processor 10 uses the obtained second address information to access the third storage area 56, and obtain the initialization program (step S13). Next, the processor 10 executes the initialization program, which is obtained in step S13 (step S14). Subsequently, the processor 10 obtains the first address information, which corresponds to the interrupt information that identifies the received interrupt, from the first information, which is saved in the second storage area 54 of the second memory 50 (step S15).

Next, the processor 10 writes back the first information, which is saved in the second storage area 54, to the first storage area 52 (step S16). In this embodiment, the processor 10 associates each piece of the first address information, which is saved in the second storage area 54, with the interrupt information (from another point of view, the interrupt information included in the second information) that is stored in the first storage area 52. Then, the processor 10 writes back the first address information. From another point of view, in this embodiment, the processor 10 rewrites the second address information, which is associated with each piece of the interrupt information that is included in the second information stored in the first storage area 52, into the first address information (the address of the interrupt handler that is executed when an interrupt, which is identified by the interrupt information, occurs) corresponding to the interrupt information.

For example, the processor 10 may be configured to obtain the first address information corresponding to the interrupt information of the received interrupt, from the first information that is written back into the first storage area 52, after the above-described process in step S16, without executing the above-described process in step S15. Namely, any configuration is possible as long as the processor 10 obtains the first address information corresponding to the interrupt information of the received interrupt, from the second memory 50.

After the above-described process in step S16, the processor 10 accesses (jumps to) an area in the first memory 20, which is specified by the first address information obtained in the above-described process in step S15, and then obtains the interrupt handler (the interrupt handler corresponding to the interrupt information of the received interrupt) that is stored in the area (step S17). Then, the processor 10 executes the obtained interrupt handler (step S18).

In this embodiment, an exemplary configuration where a program that is executed by the processor 10 after an interrupt is determined depending on the information stored in the first storage area 52 of the second memory 50, is described. This should not be construed in a limiting sense. For example, there is a processor that determines a program to execute after an interrupt depending on information recorded in a register inside the processor. This type of processor is able to save an address (first information) of an interrupt program, which is recorded in the register, into the second memory 50 in the saving process when the processor transitions to the idle state where the processor waits for an interrupt. Accordingly, it may be a configuration where a program that is executed by a processor after an interrupt is changed with a method other than changing information stored in the first storage area 52 of the second memory 50.

That is, it is not limited to the configuration where the first storage unit (the first storage area 52) and the second storage unit (the second storage area 54) are provided in the second memory 50 such as the above-described embodiment. The first storage unit stores therein the first information in which the interrupt information is associated with the first address information, while the second storage unit functions to save the first information stored in the first storage unit. It may be a configuration where at least one of the first storage unit and the second storage unit is provided in a location (for example, inside a processor) other than the second memory 50.

As described above, in this embodiment, when transitioned to the idle state, the power supply controller 40 controls to stop supplying the power to the first memory 20. On the other hand, in the case where the processor 10 receives an interrupt in the idle state, the power supply controller 40 controls to start supplying the power to the first memory 20, and the processor 10 initializes the first memory 20 to set the first memory 20 into a state where the first memory 20 is accessible from the processor. This embodiment suppresses the power supplied to the first memory 20 in the idle state, thus providing an advantageous effect that reduces power consumption of the information processing apparatus 100.

In this embodiment, even if the power to the first memory 20 is turned off when transitioning to the idle state, the first memory 20 is initialized when recovering in response to an interrupt. This allows employing, as the first memory 20, synchronous non-volatile memory such as MRAM, which does not lose information inside even though the power is turned off. More specifically, when transitioning to the idle state, the processor 10 saves the first information (information that associates the interrupt information with the first address information, which specifies an area in the first memory 20 where the interrupt handler, which is executed when an interrupt occurs, is stored) stored into the first storage area 52, into the second storage area 54. Then, the processor 10 stores the second information, in which each piece of interrupt information is associated with the address (the second address information) of the interrupt handler for initialization, in the first storage area 52. When receiving an interrupt in the idle state, the processor 10 obtains the address of the interrupt handler for initialization, which is associated with the interrupt information of the received interrupt, from the second information in the first storage area 52. Then, the processor 10 uses the obtained address of the interrupt handler for initialization to access the third storage area 56 and obtain the initialization program, and executes the obtained initialization program. The above-described configuration allows the first memory 20 to be initialized when the power is turned on again (when restarted) in response to an interrupt.

While in the embodiment described above, a synchronous non-volatile memory is employed as the first memory 20, this should not be construed in a limiting sense. A synchronous volatile memory such as SDRAM and DDR may be employed as the first memory. In short, any kind of synchronous memory may be employed as the first memory 20. For example, it is assumed that a first memory serves as a memory that temporarily holds data used for the process executed by the processor 10, and the main memory includes the first memory and a synchronous volatile memory (referred to as a third memory), which stores information (data or programs that is not to be lost) that is used for the process executed by the processor 10. With this configuration, the following configuration may be employed. When transitioning to the idle state, the power supply controller stops supplying the power to the first memory, and controls the power supplied to the third memory so as to supply the lower power than that in the active state. On the other hand, when the processor receives an interrupt in the idle state, the power supply controller resumes the supply of the power to the first memory, controls the power supplied to the third memory so as to return a value of the power to that of the power in the active state, and the processor initializes the first memory. This configuration also allows suppressing the power consumed by the first memory in the idle state, thus reducing power consumption.

Any kind of apparatus such as a PC, a mobile phone, and a tablet terminal may be employed as the information processing apparatus 100 described above.

Each of the above-described various functions of the processor 10 is achieved by executing a predetermined control program. In contrast, the control program may be stored in a computer that is coupled to a network such as the Internet in order to be downloaded and provided via the network. The above-described control program may also be provided or distributed via a network such as the Internet. Alternatively, the above-described control program may be preliminarily embedded in a ROM or other medium so as to be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirits of the inventions.

What is claimed is:

1. An information processing apparatus, comprising:
a processor configured to execute a program;
a first memory configured to store therein the program; and
a power supply controller configured to
stop supplying a power to the first memory when the processor transitions to an idle state where the processor waits for an interrupt, and
start supplying the power to the first memory when the processor receives the interrupt in the idle state, wherein
when the processor receives the interrupt in the idle state, the processor executes initialization of the first memory to set the first memory into a state where the first memory is accessible from the processor.

2. The apparatus according to claim 1, further comprising:
a second memory configured to store therein an initialization program to execute the initialization; and
a first storage unit configured to store therein first information in which interrupt information and first address information are associated with each other, the interrupt information identifying a type of the interrupt, the first address information specifying an area in the first memory in which an interrupt program is stored, the interrupt program being executed when an interrupt identified by the interrupt information occurs; and
a second storage unit, wherein
when the processor transitions to the idle state, the processor saves the first information stored in the first storage unit into the second storage unit, and stores, in the first storage unit, second information in which the interrupt information and second address information are associated with each other, the second address information specifying an area within the second memory in which the initialization program is to be stored.

3. The apparatus according to claim 2, wherein
when the processor receives the interrupt in the idle state, the processor obtains the second address information associated with the interrupt information of the received interrupt from the second information stored in the first storage unit, obtains the initialization program by accessing the second memory using the obtained second address information, executes the obtained initialization program, and writes back the first information saved in the second storage unit to the first storage unit.

4. The apparatus according to claim 3, wherein
the processor obtains the first address information corresponding to the interrupt information of the received interrupt, obtains the interrupt program corresponding to the interrupt information of the received interrupt by accessing the area specified by the obtained first address information in the first memory, and executes the obtained interrupt program.

5. The apparatus according to claim 2, wherein
the first storage unit and the second storage unit are provided in the second memory.

6. The apparatus according to claim 1, wherein
the first memory stores therein an interrupt program to be executed when the interrupt occurs, and
the processor obtains the interrupt program for the received interrupt from the first memory and executes the obtained interrupt program, after the processor finishes the initialization.

7. A computer program product comprising a computer readable medium including programmed instructions executed by a computer that includes:
a processor configured to execute a program;
a first memory configured to store therein the program; and
a power supply controller configured to stop supplying a power to the first memory when the processor transitions to an idle state where the processor waits for an interrupt, and start supplying the power to the first memory when the processor receives the interrupt in the idle state,
the instructions, when executed by the computer, cause the computer to perform:
executing initialization of the first memory to set the first memory into a state where the first memory is accessible from the processor, when the processor receives the interrupt in the idle state.
